(19) United States
(12) Patent Application Publication
(10) Pub. No.: US 2026/0079424 A1
(43) Pub. Date: Mar. 19, 2026

(54) IMAGE FORMING APPARATUS

(71) Applicant: CANON KABUSHIKI KAISHA, Tokyo (JP)

(72) Inventors: SHUNSUKE HIJIKATA, Kanagawa (JP); YUKIO KUBO, Tokyo (JP); ISAO KOISHI, Kanagawa (JP); NAOKI HAYASHI, Kanagawa (JP); YUUJI OBUKURO, Saitama (JP); YU FUKASAWA, Tokyo (JP)

(21) Appl. No.: 19/323,788

(22) Filed: Sep. 9, 2025

(30) Foreign Application Priority Data
Sep. 13, 2024 (JP) 2024-158771

(51) Int. Cl. G03G 15/08; G03G 15/04; G03G 21/18

(52) U.S. Cl. CPC G03G 15/0879; G03G 15/04072; G03G 15/0409; G03G 15/0813; G03G 15/0863; G03G 15/0865; G03G 21/1814; G03G 2215/0404

(57) ABSTRACT

An image forming apparatus is configured such that a second photosensitive drum is disposed between a first toner container and a first developing container in a first direction, a part of a first pipe is disposed to pass a region outside a light path of a laser beam radiated from a laser scanner to the second photosensitive drum in a second direction, and at least a part of a wall is a region between the part of the first pipe and the light path in the second direction and is disposed in a region overlapping with the light path when viewed in a direction of a rotational axis of the second photosensitive drum.

### BACKGROUND

### Field

The present disclosure relates to an image forming apparatus and a toner container used for the image forming apparatus.

### Description of the Related Art

An electrophotographic image forming apparatus is known to be configured to supply a toner to a developing container in the image forming apparatus by using a toner container attachable to and detachable from the image forming apparatus. For example, Japanese Patent Application Laid-Open No. 2023-007030 describes a configuration in which a user attaches a toner container on the front face side, i.e., the side where a user is standing, of an image forming apparatus and supplies a toner to the toner container, and the toner supplied to the toner container is conveyed to a developing container by a screw.

### SUMMARY

According to some embodiments of the present disclosure, an image forming apparatus includes a laser scanner, a first photosensitive drum configured to be irradiated with a laser beam by the laser scanner to form an electrostatic latent image on a surface of the first photosensitive drum, the first photosensitive drum being configured to be rotatable, a second photosensitive drum configured to be irradiated with a laser beam by the laser scanner to form an electrostatic latent image on a surface of the second photosensitive drum, the second photosensitive drum being arranged in line with the first photosensitive drum in a first direction intersecting with a gravitational direction, a first developing unit including a first developing roller configured to supply a first toner to the first photosensitive drum to develop a first toner image, and a first developing container configured to store the first toner to be carried by the first developing roller, a second developing unit including a second developing roller configured to supply a second toner to the second photosensitive drum to develop a second toner image, and a second developing container configured to store the second toner to be carried by the second developing roller, a first toner container configured to store the first toner to be supplied to the first developing container, a second toner container configured to store the second toner to be supplied to the second developing container, the second toner container being arranged in line with the first toner container in a second direction intersecting with the gravitational direction and the first direction, a first pipe configured to allow the first toner to be supplied from the first toner container to the first developing container to pass through, the first pipe being bendable and flexible, a second pipe configured to allow the second toner to be supplied from the second toner container to the second developing container to pass through, the second pipe being bendable and flexible; and a wall configured to regulate a position of the first pipe, wherein the second photosensitive drum is disposed between the first toner container and the first developing container in the first direction, wherein, in the second direction, a part of the first pipe is disposed to pass a region outside a light path of the laser beam radiated from the laser scanner to the second photosensitive drum, and wherein at least a part of the wall is a region between the part of the first pipe and the light path in the second direction, and is disposed in a region overlapping with the light path when viewed in a direction of a rotational axis of the second photosensitive drum.

Further features of the present disclosure will become apparent from the following description of exemplary embodiments with reference to the attached drawings.

### BRIEF DESCRIPTION OF THE DRAWINGS

FIGS. 1A and 1B are a characteristic cross-sectional view and a characteristic enlarged cross-sectional view, respectively, illustrating an image forming apparatus of the present disclosure.

FIG. 2 is a cross-sectional view illustrating the entire image forming apparatus according to a first exemplary embodiment.

FIGS. 3A to 3C are perspective views illustrating the entire image forming apparatus according to the first exemplary embodiment.

FIGS. 4A and 4B are perspective views illustrating an image forming unit according to the first exemplary embodiment.

FIG. 5 is a top view illustrating the image forming unit according to the first exemplary embodiment.

FIGS. 6A and 6B are cross-sectional views illustrating the image forming unit according to the first exemplary embodiment.

FIG. 7 is a cross-sectional view illustrating a cross-section, parallel to light paths, of the image forming unit according to the first exemplary embodiment.

FIGS. 8A and 8B are cross-sectional views illustrating a process unit according to the first exemplary embodiment.

FIGS. 9A and 9B are top views illustrating the image forming unit according to the first exemplary embodiment.

FIGS. 10A and 10B are cross-sectional views illustrating a cross-section, parallel to the light paths, of the image forming unit according to the first exemplary embodiment.

FIGS. 11A to 11C are perspective views illustrating the image forming unit according to another form of the first exemplary embodiment.

FIG. 12 is a perspective view illustrating the image forming unit according to another form of the first exemplary embodiment.

FIG. 13 is a cross-sectional view illustrating an image forming unit in a pulling direction according to a second exemplary embodiment.

FIG. 14 is a perspective view illustrating the image forming unit according to the second exemplary embodiment.

### DESCRIPTION OF THE EMBODIMENTS

### Image Forming Apparatus

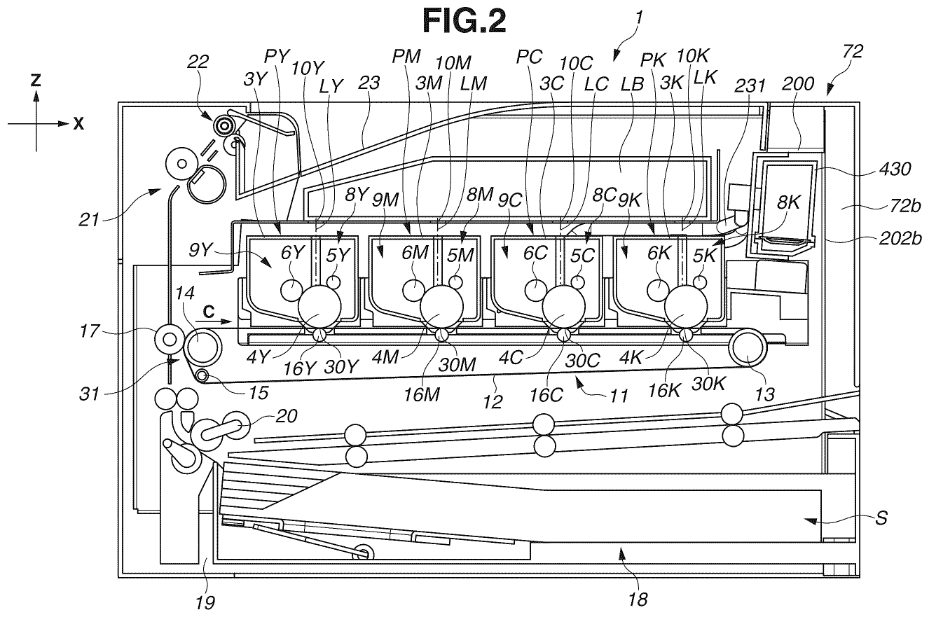

An image forming apparatus 1 according to a first exemplary embodiment of the present disclosure will be described below with reference to FIG. 2. An electrophotographic image forming apparatus according to the present exemplary embodiment is a full color image forming apparatus having process units for four respective colors. FIG. 2 illustrates a main cross-section of the image forming apparatus 1.

The image forming apparatus 1 is an electrophotographic full-color laser printer capable of forming a full color image on a recording medium S. The image forming apparatus 1 includes process units PY, PM, PC, and PK (hereinafter collectively referred to as process units P) and an apparatus main body 72. The process units P are disposed in line in a first direction X, which is the horizontal direction parallel to the ground contact surface of the image forming apparatus 1. The process units P store toners of respective colors. The process unit PY stores a yellow toner. The process unit PM stores a magenta toner. In the following descriptions, the process unit PC stores a cyan toner. The process unit PK stores a black toner. The trailing letters (Y, M, C, and K) of the reference signs represent the initial letters of the respective toner colors: yellow, magenta, cyan, and black, respectively, and this applies to other reference signs in the same manner.

The longitudinal direction of the process units P is a second direction Y perpendicular to the first direction. Like the first direction, the second direction Y is parallel to the ground contact surface of the image forming apparatus 1. The process units PY, PM, PC, and PK are referred to as a first process unit, a second process unit, a third process unit, and a fourth process unit, respectively.

Each process unit P includes components used for the electrophotographic process. A rotary driving force is transmitted from a drive output unit (not illustrated) of the apparatus main body 72 to the process units P. The process units P are supplied with bias voltages (such as a charge bias and a developing bias) from a bias application unit (not illustrated) of the apparatus main body 72.

As illustrated in FIG. 2, the process units P include drum units 8Y, 8M, 8C, and 8K (hereinafter collectively referred to as drum units 8 with the symbols indicating the toner colors omitted), and developing units 9Y, 9M, 9C, and 9K (hereinafter collectively referred to as developing units 9), respectively. The drum units 8Y, 8M, 8C, and 8K are referred to as a first drum unit, a second drum unit, a third drum unit, and a fourth drum unit, respectively.

The drum units 8 include photosensitive drums 4Y, 4M, 4C, and 4K (hereinafter collectively referred to as photosensitive drums 4), and charge rollers 5Y, 5M, 5C, and 5K (hereinafter collectively referred to as charge rollers 5), respectively, as process units acting on the photosensitive drums 4. The photosensitive drums 4 are disposed to be rotatable so that their rotational axes (first rotational axes) correspond to the second direction Y. The photosensitive drums 4Y, 4M, 4C, and 4K are referred to as a first photosensitive drum, a second photosensitive drum, a third photosensitive drum, and a fourth photosensitive drum, respectively.

The developing units 9 include developing rollers 6Y, 6M, 6C, and 6K (hereinafter collectively referred to as developing rollers 6) for developing electrostatic latent images on the photosensitive drums 4. The developing units 9 are arranged in line in the first direction X. The developing rollers 6Y, 6M, 6C, and 6K are referred to as a first developing roller, a second developing roller, a third developing roller, and a fourth developing roller, respectively. The developing units 9Y, 9M, 9C, and 9K are referred to as a first developing unit, a second developing unit, a third developing unit, and a fourth developing unit, respectively.

The developing unit 9Y includes a developing container 3Y (first developing container) for storing a yellow (Y) toner (first toner), and is configured such that the developing roller 6Y carrying the yellow (Y) toner supplies the yellow (Y) toner onto the surface of the photosensitive drum 4Y.

The developing unit 9M includes a developing container 3M (second developing container) for storing a magenta (M) toner (second toner), and is configured such that the developing roller 6M carrying the magenta (M) toner supplies the magenta (M) toner onto the surface of the photosensitive drum 4M.

The developing unit 9C includes a developing container 3C (third developing container) for storing a cyan (C) toner (third toner), and is configured such that the developing roller 6C carrying the cyan (C) toner supplies the cyan (C) toner onto the surface of the photosensitive drum 4C.

The developing unit 9K includes a developing container 3K (fourth developing container) for storing a black (K) toner (fourth toner), and is configured such that the developing roller 6K carrying the black (Y) toner supplies the black (K) toner onto the surface of the photosensitive drum 4K.

A laser scanner unit LB (an exposure unit or a laser scanner) is disposed above the process units P (photosensitive drums 4) in a third direction Z intersecting with both the first direction X and the second direction Y. The third direction Z is the gravity direction perpendicular to the ground contact of the image forming apparatus 1.

The laser scanner unit LB outputs laser beams corresponding to image information. Hereinafter, the light paths of the laser beams toward the photosensitive drums 4Y, 4M, 4C, and 4K are referred to as a light path LY (first light path), a light path LM (second light path), a light path LC (third light path), and a light path LK (fourth light path), respectively (hereinafter individually referred to as each light path L and collectively referred to as light paths L).

The photosensitive drum 4Y is irradiated with a first laser beam. The first laser beam passes through the first light path. The photosensitive drum 4M is irradiated with a second laser beam. The second laser beam passes through the second light path. The photosensitive drum 4C is irradiated with a third laser beam. The third laser beam passes through the third light path. The photosensitive drum 4K is irradiated with a fourth laser beam. The fourth laser beam passes through the fourth light path.

The deflected and scanned laser beams pass through exposure windows 10Y, 10M, 10C, and 10K of the laser scanner unit LB and are radiated onto the surfaces of the photosensitive drums 4. A light emitting diode (LED) exposure unit may be used instead of the laser scanner unit LB.

An intermediate transfer belt unit 11 as a transfer member is disposed below the process units P in the third direction Z. The intermediate transfer belt unit 11 includes a drive roller 14, a tension roller 13, and an assist roller 15, and a flexible transfer belt 12 is looped around these rollers.

The bottom surfaces of the photosensitive drums 4 are in contact with the upper surface of the transfer belt 12. The contact portions between the photosensitive drums 4 and the transfer belt 12 form primary transfer portions 30Y, 30M, 30C, and 30K (hereinafter collectively referred to as primary transfer portions 30). The inner side of the transfer belt 12 is provided with primary transfer rollers 16Y, 16M, 16C, and 16K (hereinafter collectively referred to as transfer rollers 16) facing the respective photosensitive drums 4.

A secondary transfer roller 17 is pressed onto the drive roller 14 via the transfer belt 12. The contact portion between the transfer belt 12 and the secondary transfer roller 17 corresponds to a second transfer portion 31.

A paper feed unit 18 is disposed below the intermediate transfer belt unit 11 in the third direction Z. The paper feed unit 18 includes a paper feed tray 19 for storing recording media S stacked on one another, and a feed roller 20 for picking up and conveying each recording medium S from the paper feed tray 19.

Referring to FIG. 2, the upper part of the apparatus main body 72 is provided with a fixing unit 21 for fixing a toner image onto the recording medium S, and a discharge roller 22 for discharging the recording medium S with a toner image fixed thereto to a discharge tray 23. The discharge roller 22 discharges the recording medium S in a direction substantially corresponding to the first direction X.

According to the present exemplary embodiment, in the first direction X, the front face side of the image forming apparatus 1 refers to the downstream side in the discharge direction in which the recording medium S is discharged toward the discharge tray 23 by the discharge roller 22, and the rear face side of the image forming apparatus 1 refers to the upstream side in the discharge direction.

### Image Forming Operation

An image forming operation for forming a full color image will be described below. Referring to FIG. 2, the photosensitive drums 4 are driven to rotate at a predetermined speed in the counterclockwise direction. The transfer belt 12 is driven to rotate at a speed corresponding to the rotational speed of the photosensitive drums 4 in the forward direction (direction of the arrow C in FIG. 2) with respect to the rotation of the photosensitive drums 4.

The laser scanner unit LB is also driven. The charge rollers 5 (5Y, 5M, 5C, and 5K) in the process units P uniformly charge the surfaces of the respective photosensitive drums 4 to a predetermined polarity and potential in synchronization with the driving of the laser scanner unit LB.

The laser scanner unit LB scans and exposes the charged surfaces of the photosensitive drums 4 with laser beams corresponding to image signals for the respective colors. Electrostatic latent images corresponding to the image signals for the respective colors are formed on the surfaces of the photosensitive drums 4.

More specifically, the laser scanner unit LB exposes the photosensitive drum 4Y to form a first electrostatic latent image (first toner image) on the photosensitive drum 4Y. Likewise, the laser scanner unit LB exposes the photosensitive drums 4M, 4C, and 4K to form a second electrostatic latent image (second toner image), a third electrostatic latent image (third toner image), and a fourth electrostatic latent image (fourth toner image) on the photosensitive drums 4M, 4C, and 4K, respectively.

The electrostatic latent images on the photosensitive drums 4 are developed by toners supplied to the photosensitive drums 4 via the developing rollers 6, which is driven to rotate at a predetermined speed in the clockwise direction in FIG. 2.

The above-described electrophotographic image forming process forms a yellow toner image on the photosensitive drum 4Y of the process unit PY. Then, the yellow toner image is primarily transferred onto the transfer belt 12. Likewise, a magenta toner image is formed on the photosensitive drum 4M of the process unit PM. Then, the magenta toner image is primarily transferred onto the transfer belt 12 so as to be superimposed on the yellow toner image on transfer belt 12. Furthermore, a cyan toner image is formed on the photosensitive drum 4C of the process unit PC. Then, the cyan toner image is primarily transferred onto the transfer belt 12 so as to be superimposed on the yellow and magenta toner images on the transfer belt 12. Likewise, a black toner image is formed on the photosensitive drum 4K of the process unit PK. Then, the black toner image is primarily transferred onto the transfer belt 12 so as to be superimposed on the yellow, magenta, and cyan toner images on the transfer belt 12.

In this way, an unfixed full color (four-color) toner image, which is formed of the yellow, magenta, cyan, and black toner images, is formed on the transfer belt 12. Meanwhile, at predetermined control timings, each recording medium S is separately fed from the paper feed tray 19 by the feed roller 20. The recording medium S is conveyed to the second transfer portion 31, which is a contact portion between the secondary transfer roller 17 and the transfer belt 12, at a predetermined control timing. In the process of conveying the recording medium S through the second transfer portion 31, the toner image formed of four color toners superimposed on the transfer belt 12 is transferred to the recording medium S.

The recording medium S with the toner image transferred thereto is heated and pressurized by the fixing unit 21, and the toner image is fixed to the recording medium S. The recording medium S with the toner image fixed thereto is discharged to the discharge tray 23 by the discharge roller 22.

### Detachably Attachable Cartridges

The image forming apparatus 1 includes cartridges 430Y, 430M, 430C, and 430K (hereinafter collectively referred to as cartridges 430) attachable to and detachable from the apparatus main body 72. The cartridges 430 are arranged in line in the second direction Y. More specifically, the cartridges 430 are arranged in line in the direction intersecting with the direction in which the developing units 9 are arranged in line. The cartridges 430Y, 430M, 430C, and 430K are referred to as a first cartridge (first toner container), a second cartridge (second toner container), a third cartridge (third toner container), and a fourth cartridge (fourth toner container), respectively.

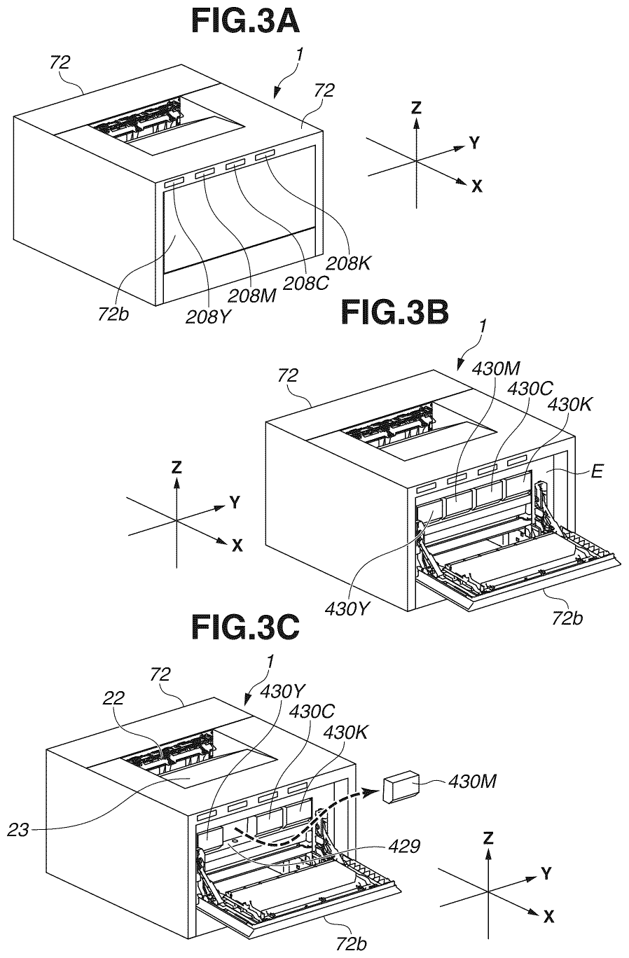

FIG. 3A is a perspective view illustrating the image forming apparatus 1 in a state where a front door 72b is closed. FIG. 3B is a perspective view illustrating the image forming apparatus 1 in a state where the front door 72b is open. FIG. 3C is a perspective view illustrating the image forming apparatus 1 in a state where the front door 72b is open and the cartridge 430M is detached from a cartridge holder 429.

The cartridges 430 are attached at the upper part on the front face side of the apparatus main body 72 so that each cartridge 430 is accessible when the front door 72b is open. In other words, the cartridges 430 are disposed at the downstream end of the apparatus main body 72 in the discharge direction of the recording medium S discharged by the discharge roller 22. The front door 72b is configured to be movable between a closed position where an opening E on the front face side of the apparatus main body 72 is closed (see FIG. 3A) and an open position where the opening E is exposed. (see FIG. 3B). When the front door 72b is moved to the open position, the cartridges 430 are exposed to the outside of the image forming apparatus 1 through the opening E, as illustrated in FIG. 3B. The cartridges 430 are arranged next to each other in the second direction Y and configured to be attached to and detached from the apparatus main body 72 in first direction X, as illustrated in FIG. 3C. The first direction X and the second direction Y perpendicularly intersect with each other. This arrangement allows the user to supply a toner to each process unit P without detaching the process unit P from the apparatus main body 72. Since the cartridges 430 are arranged on the front face side of the image forming apparatus 1, each cartridge 430 can be accessed from the front face side like the case of collecting the recording medium S discharged onto the discharge tray 23. Furthermore, Since the cartridge holder 429 for holding the cartridges 430 is provided on the front face side of the image forming apparatus 1, none of the process units P is exposed even after each cartridge 430 is removed (FIG. 3C). The cartridges 430 are stored in the apparatus main body 72 in a state where the front door 72b is closed.

As illustrated in FIG. 3A, the front face of the image forming apparatus 1 is provided with indicators 208Y, 208M, 208C, and 208K (hereinafter collectively referred to as indicators 208 which may be collectively referred to as an indication unit or display unit). The indicators 208 are arranged in the second direction Y to correspond to the cartridges 430. The indicator 208Y (first indicator) is for yellow, the indicator 208M (second indicator) is for magenta, the indicator 208C (third indicator) is for cyan, and the indicator 208K (fourth indicator) is for black. Each indicator 208 is formed of a light emitting diode (LED) or seal of the toner color corresponding to each cartridge 430. To prevent wrong attachment of the cartridges 430, each indicator 208 is provided to indicate the toner color of the cartridge 430 to be attached for the user. Each indicator 208 may be provided with a function of displaying the remaining amount of toner for the corresponding process unit P (developing unit 9).

### Toner Conveyance

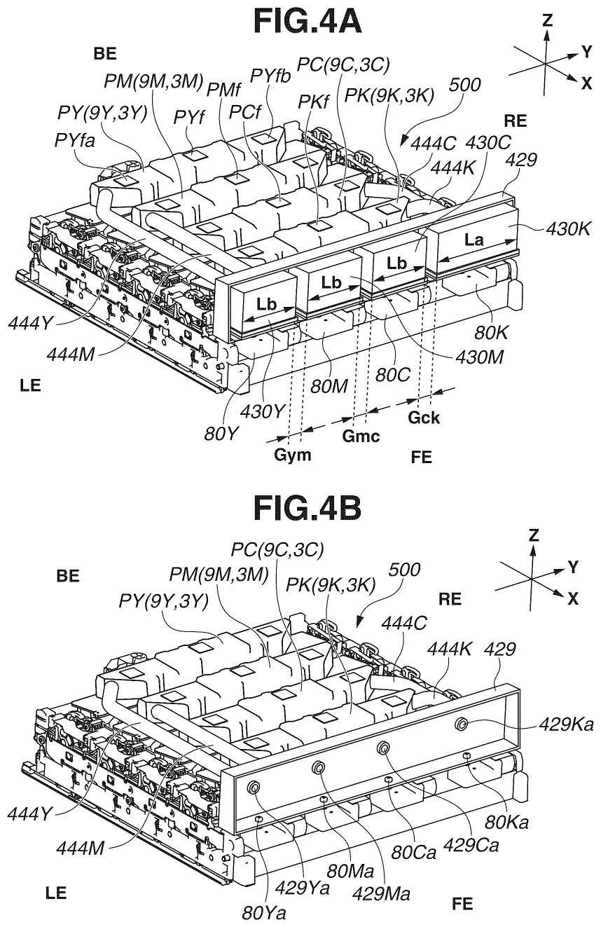

A toner conveyance mechanism ranging from the cartridges 430 to the corresponding process units P will be described below with reference to FIGS. 4A, 4B, 5, 6A, and 6B.

An image forming unit 500 includes the four cartridges 430, the four process units P, and four conveyance paths for conveying toners from the cartridges 430 to the process units P, and is configured to integrally hold these members.

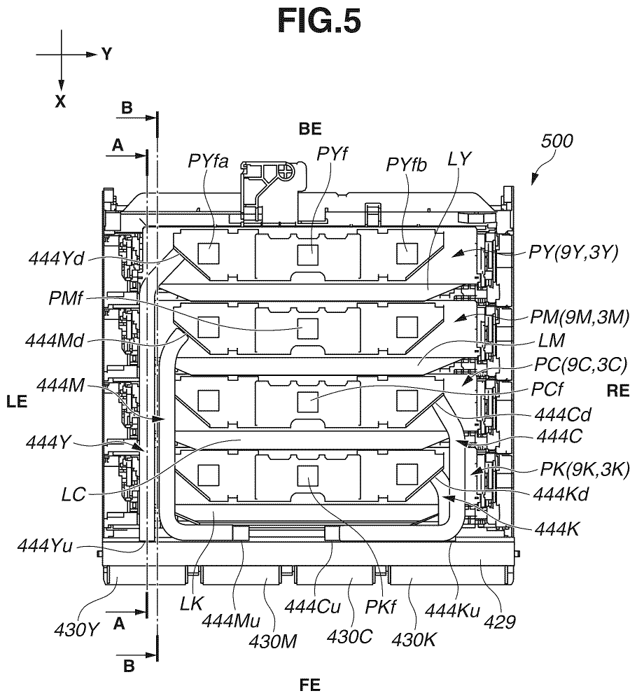

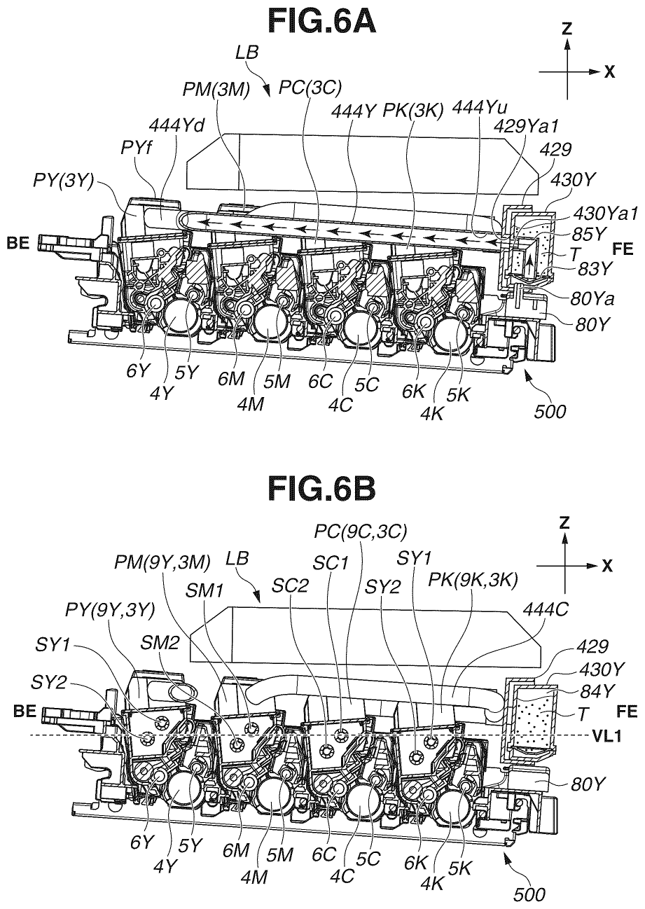

FIG. 4A is a perspective view illustrating the image forming unit 500 in a state where the cartridges 430 are attached. FIG. 4B is a perspective view illustrating the image forming unit 500 in a state where the cartridges 430 are detached. FIG. 5 is a top view illustrating the image forming unit 500. FIGS. 6A and 6B are cross-sectional views taken along the A-A and B-B lines of FIG. 5, respectively.

As illustrated in FIG. 4A, pump units 80Y, 80M, 80C, and 80K (hereinafter collectively referred to as pump units 80) are provided below the cartridge holder 429. The pump units 80 are arranged in line in the second direction Y. The pump units 80Y, 80M, 80C, and 80K are referred to as a first pump unit, a second pump unit, a third pump unit, and a fourth pump unit, respectively. As the pump units 80, volumetric pumps, such as reciprocating pumps and rotary pumps, are used. Reciprocating pumps perform suction and discharge by a reciprocating motion of a piston or plunger. Types of reciprocating pumps include piston pumps, plunger pumps, and diaphragm pumps. Rotary pumps perform suction and discharge by a rotary motion of a gear or rotor. Types of reciprocating pumps include gear pumps, screw pumps, and vane pumps. The four pump units 80 may be configured as one pump unit. Although, in the present exemplary embodiment, the pump units 80 are disposed in the apparatus main body 72, they may be disposed in the respective cartridges 430.

As illustrated in FIG. 4B, at the positions where the bottom surfaces of the cartridges 430 face the cartridge holder 429, there are provided with the pump units 80 configured to raise and lower the air pressure to move air. There are provided with openings where discharge ports 80Ya, 80Ma, 80Ca, and 80Ka (hereinafter collectively referred to as discharge ports 80a) for discharging the air produced by the pump units 80 are exposed. The discharge ports 80a are upwardly opened.

The air discharged upwardly from the discharge ports 80a is supplied to the cartridges 430 attached to the cartridge holder 429.

How the air supplied to the cartridges 430 is conveyed to the developing units 9 together with toners will be described below with reference to FIG. 6A.

Although FIG. 6A illustrates the cartridge 430Y, the cartridges 430M, 430C, and 430K are configured in a similar way to the cartridge 430Y. Therefore, only the yellow color will be described below. The cartridge 430Y is provided with a mesh-type filter 83Y configured to allow air passage and block a toner. The air supplied from the discharge port 80Ya passes through the filter 83Y and mixes with the toner. The toner mixed with air passes through a discharge pipe (passage) 85Y formed in the cartridge 430Y and is discharged out of the cartridge 430Y through a discharge port 430Ya1 of the cartridge 430Y.

The toners discharged from the cartridges 430 are received together with air by a supply pipe 444Y (first toner conveyance path, first conveyance path, or first pipe), a supply pipe 444M (second toner conveyance path, second conveyance path, or second pipe), a supply pipe 444C (third toner conveyance path, third conveyance path, or third pipe), and a supply pipe 444K (fourth toner conveyance path, fourth conveyance path, or fourth pipe) (hereinafter collectively referred to as supply pipes 444) through receiving inlets 429Ya, 429Ma, 429Ca, and 429Ka (hereinafter collectively referred to as receiving inlets 429a), respectively, provided on the cartridge holder 429 illustrated in FIG. 4B.

The supply pipes 444 extending from the corresponding cartridges 430 to the corresponding developing units 9 are made of a flexible and toner-resistant material allowing toner conveyance. For example, if the supply pipes 444 are made of polyurethane, silicon, nylon, or polyolefin, they can be formed as bendable flexible tubes having a variable shape.

The receiving inlets 429a are through holes disposed to penetrate through the surface of the cartridge holder 429 facing the rear faces of the cartridges 430. The receiving inlets 429a is opened substantially toward the first direction X in which the developing units 9 are arranged. The direction in which the receiving inlets 429a are opened intersects with the direction in which the discharge ports 80a are opened.

On the rear face side of the cartridge holder 429 in FIG. 4B where the receiving inlets 429a are provided, as illustrated in FIG. 5, the supply pipes 444 are connected with the cartridge holder 429 such that upstream ends 444Yu, 444Mu, 444Cu, and 444Ku (hereinafter collectively referred to as upstream ends 444u) of the supply pipes 444 communicate with the receiving inlets 429a in FIG. 4B.

The toners mixed with the air received from the receiving inlets 429a are moved inside the supply pipes 444 from the upstream ends 444u to downstream ends 444Yd, 444Md, 444Cd, and 444Kd (hereinafter referred to as downstream ends 444d) and then supplied to the developing units 9.

The downstream ends 444d of the supply pipes 444 are connected with the ends of the developing units 9 in the second direction Y. More specifically, the downstream end 444Yd of the supply pipe 444Y and the downstream end 444Md of the supply pipe 444M are connected with the end of the developing unit 9Y and the end of the developing unit 9M, respectively, on the LE side. The downstream end 444Cd of the supply pipe 444C and the downstream end 444Kd of the supply pipe 444K are connected with the end of the developing unit 9C and the end of the developing unit 9K, respectively, on the RE side.

Since the pipe length is proportional to the pressure loss from the viewpoint of general fluid mechanics, this configuration is intended to decrease the pressure loss with the reduced lengths of the supply pipes 444. This allows selection of small-sized pump units 80 and therefore the size of the image forming unit 500 can be reduced. All of the four supply pipes 444 may be disposed on the LE or the RE side. Alternatively, three supply pipes 444 may be disposed on one side, and one supply pipe 444 may be disposed on the other side.

The arrangement of the cartridge 430Y will be described below. As illustrated in FIG. 6B, the cartridge 430Y and the process units P (developing units 9) are disposed to be on a virtual line VL1 extending in the first direction X. More specifically, the cartridge 430Y is disposed in line with the developing units 9 in the first direction X. In other words, when viewed along the first direction X, the cartridge 430Y is disposed so that at least a part thereof overlaps with the developing units 9. The cartridges 430M, 430C, and 430K are also arranged in line with the developing units 9 in the first direction X. In other words, when viewed along the first direction X, the cartridges 430M, 430C, and 430K are disposed so that at least a part of each cartridge overlaps with the developing units 9. Such arrangements of the cartridges 430 enable a reduction in the height of the image forming apparatus 1 in the third direction Z, and thus, the size of the image forming apparatus 1 can be reduced. The cartridges 430 may be partly disposed above the process units (developing units 9) in the third direction Z.

### Covers of Supply Pipes

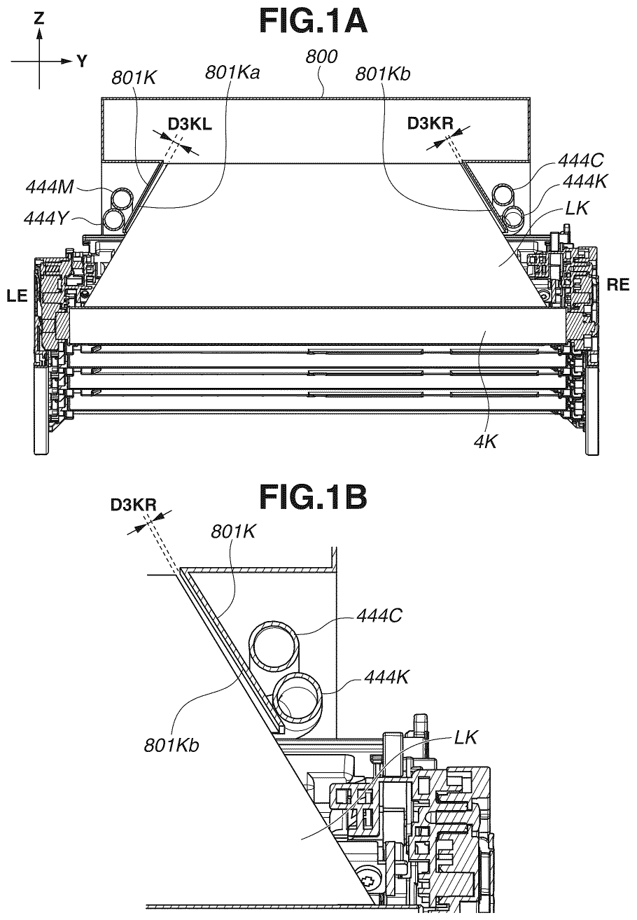

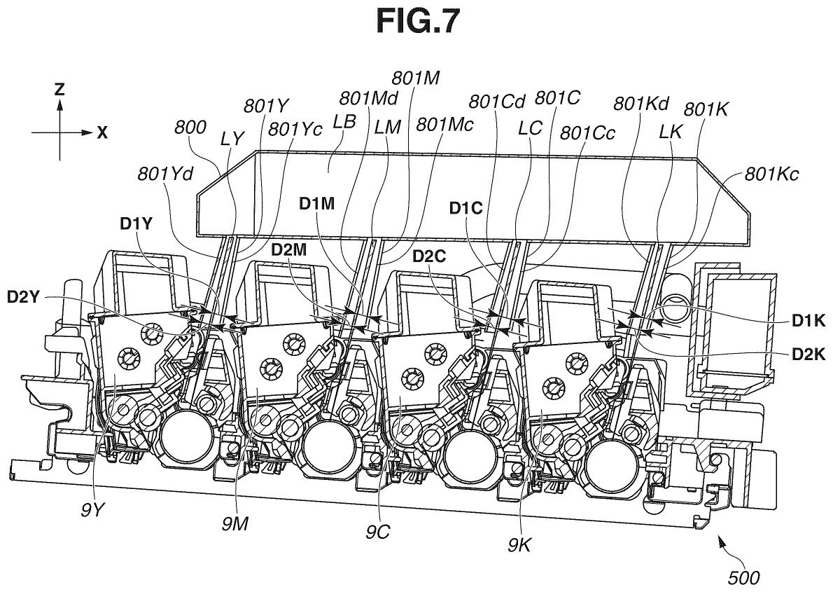

The arrangements of the supply pipes 444 and a scanner cover 800 as features of the present exemplary embodiment will be described below with reference to FIGS. 1A, 1B, and 7.

FIGS. 1A and 1B are cross-sectional views taken along a cross-section parallel to the plane formed by the light path LK of the laser beam deflected and scanned by the laser scanner unit LB illustrated in FIG. 7. FIG. 7 is a cross-sectional view illustrating the image forming unit 500 in a state where the laser scanner unit LB emits light, viewed from the direction Y.

As illustrated in FIGS. 1A, 1B, and 7, the scanner cover 800 covers the outside of the laser scanner unit LB. The scanner cover 800 is provided with covers formed to cover the light paths L for forming latent images on the photosensitive drums 4.

More specifically, the scanner cover 800 includes a scanner light path cover 801Y for covering the light path LY for forming a latent image on the photosensitive drum Y, a scanner light path cover 801M for covering the light path LM for forming a latent image on the photosensitive drum M, a scanner light path cover 801C for covering the light path LC for forming a latent image on the photosensitive drum C, and a scanner light path cover 801K for covering the light path LK for forming a latent image on the photosensitive drum K (hereinafter collectively referred to as scanner light path covers 801).

As illustrated in FIG. 1A, a laser light flux is deflected and scanned by mirrors and lenses (not illustrated) disposed inside the laser scanner unit LB. The range of the deflected and scanned laser light flux expands in a fan-like manner as the light travels away from the laser scanner unit LB. The laser light flux having arrived at the photosensitive drum 4K forms a latent image on the surface of the photosensitive drum 4K.

Therefore, the scanner light path cover 801K is formed of a guide shape along the fan-like shape of the light path LK. More specifically, a guide shape 801Ka (first wall portion) of the scanner light path cover 801K is formed away from the light path LK by a predetermined distance D3KL on one end side in the direction Y. A guide shape 801Kb (second wall portion) is formed away from the light path LK by a predetermined distance D3KR on the other end side opposite to the one end side.

In the apparatus main body 72, the supply pipes 444 are located further outward than the scanner light path cover 801K. More specifically, supply pipes 444Y and 444M are located outward to the LE side relative to the scanner light path cover 801K, and supply pipes 444C and 444K are located outward to the RE side relative to the scanner light path cover 801K.

In other words, the guide shapes 801Ka and 801Kb, which are parts of the scanner cover 800 or walls, are formed in the regions between each supply pipe 444 and the light path LK to regulate the movements of the supply pipes 444.

The present exemplary embodiment has been described above centering on the scanner light path cover 801K of the station corresponding to the black toner color. However, the description also applies to the light path covers 801Y, 801M, and 801C (not illustrated) corresponding to other toner colors.

A shape similar to the guide shape 801Ka of the scanner light path cover 801Y is referred to as a guide shape 801Ya. A shape similar to the guide shape 801Kb of the scanner light path cover 801Y is referred to as a guide shape 801Yb. A shape similar to the guide shape 801Ka of the scanner light path cover 801M is referred to as a guide shape 801Ma. A shape similar to the guide shape 801Kb of the scanner light path cover 801M is referred to as a guide shape 801Mb. A shape similar to the guide shape 801Ka of the scanner light path cover 801C is referred to as a guide shape 801Ca. A shape similar to the guide shape 801Kb of the scanner light path cover 801C is referred to as a guide shape 801Cb.

The guide shapes 801Ka, 801Ca, 801Ma, and 801Ya are collectively referred to as guide shapes 801a. The guide shapes 801Kb, 801Cb, 801Mb, and 801Yb are collectively referred to as guide shapes 801b.

As illustrated in FIG. 7, the scanner light path covers 801 are configured as follows. Guide members 801Yc, 801Mc, 801Cc, and 801Kc (hereinafter collectively referred to as guide members 801c and also referred to as third wall portions) are formed at positions away from the light paths L by distances D1Y, D1M, D1C, and D1K, respectively, on one side in the Y direction. Guide members 801Yd, 801Md, 801Cd, and 801Kd (hereinafter collectively referred to as guide members 801d and also referred to as fourth wall portions) are formed at positions away from the light paths L by distances D2Y, D2M, D2C, and D2K, respectively, on the other side opposite to the side where guide members 801c are disposed.

The positions of the guide shape 801Ka (first wall portion) and the guide shape 801Kb (second wall portion) in FIG. 1A are equivalent to the connecting portions of the guide shape 801Kc (third wall portion) and the guide shape 801Kd (fourth wall portion) in FIG. 7. The portions including the portions between the guide shape 801Kc (third wall portion) and the guide shape 801Kd (fourth wall portion) correspond to the guide shape 801Ka (first wall portion) and the guide shape 801Kb (second wall portion). This also applies to the stations of colors other than black (K). In this way, the guide shape 801Ka (first wall portion) and the guide shape 801Kb (second wall portion) are located so that their positions overlap with the light paths L.

Thus, the guide members 801a, 801b, 801c, and 801d of the scanner light path covers 801 as parts of the same laser scanner unit LB form connected guide shapes with respect to the light paths L. Since light is emitted from the laser scanner unit LB through the light paths L as described above, an assembly error can be reduced by forming light emitting members and guide members as a single unit. In comparison with a case where these members are formed as different units, the above-described single-unit configuration providing a smaller assembly error enables prevention of each light path L from being blocked even with a shorter distance between the light path L and each guide member.

The laser scanner unit LB includes a laser light source for emitting laser beams, polygon mirrors for reflecting, deflecting, and scanning the laser beams emitted from the laser light source, and an optical box for storing these components. The optical box also stores a lens group for focusing the deflected and scanned laser beams on the surfaces of the photosensitive drums 4Y, 4M, 4C, and 4K. The optical box is a housing for integrally holding these components, which is molded by injection-molding. The scanner light path covers 801 are integrally formed with the optical box. The scanner light path covers 801 may be configured as parts integrally formed with the optical box by injection-molded. The scanner light path covers 801 may be attached to and integrally connected with the optical box as parts different from the optical box by using an adhesion method or screw-fastening method.

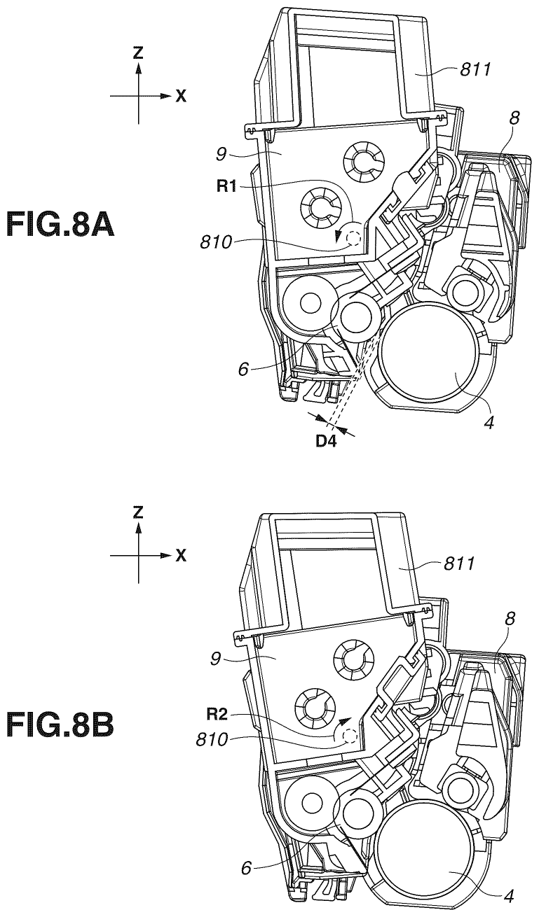

The process units P may be configured to perform a contact/separation operation with respect to the photosensitive drums 4 from the viewpoint of the lifetime of the developing rollers 6. The operation is illustrated in FIGS. 8A and 8B. FIG. 8A illustrates a state where a developing roller 6 is separated from a photosensitive drum 4 (state at the separation position). FIG. 8B illustrates a state where the developing roller 6 is in contact with the photosensitive drum 4 (state at the contact position).

The developing unit 9 can be repetitively operated by a driving force (not illustrated) so that it takes the positions and orientations in the states in FIGS. 8A and 8B. More specifically, when the developing unit 9 in the state in FIG. 8A rotates in the direction R1 around the rotation center 810 (second rotational axis), the developing unit 9 enters the state in FIG. 8B. When the developing unit 9 in the state in FIG. 8B rotates in the direction R2 around the rotation center 810, the developing unit 9 enters the state in FIG. 8A.

A cap 811 of each developing unit 9 is connected to the corresponding supply pipe 444. Therefore, when the developing unit 9 performs the contact/separation operation, the portion of each cap 811 connected to the supply pipe 444 also moves in conjunction with the contact/separation operation.

More specifically, when the state changes from the state in FIG. 8A to the state in FIG. 8B (from the separation state to the contact state), the cap 811 moves in the direction opposite to the X direction indicated by the arrow. When the state changes from the state in FIG. 8B to the state in FIG. 8A (from the contact state to the separation state), the cap 811 moves in the X direction indicated by the arrow.

Using a flexible material, not a rigid material, in the supply pipes 444 enables the supply pipes 444 to follow the movement of the caps 811.

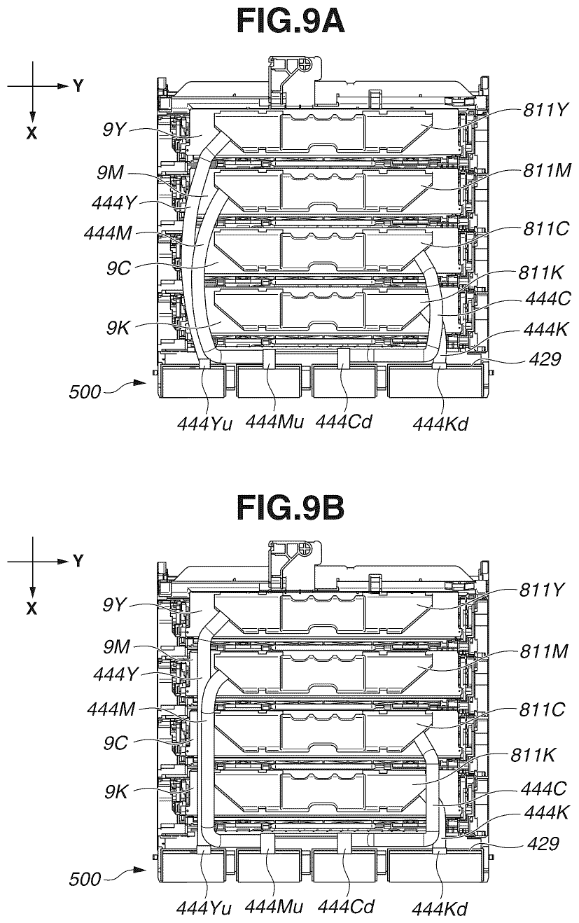

The operation of each supply pipe 444 will be specifically described below with reference to FIGS. 9A and 9B. FIG. 9A is a plan view illustrating the image forming unit 500 as viewed from above in a state where the developing rollers 6 are separated from the photosensitive drums 4. FIG. 9B is a plan view illustrating the image forming unit 500 as viewed from above in a state where the developing rollers 6 are in contact with the photosensitive drums 4.

As illustrated in FIG. 9A, the flexible supply pipes 444 flex and are disposed so that they form arcs in a state where the developing rollers 6 (not illustrated) are separated from the photosensitive drums 4 (not illustrated). In other words, the supply pipes 444 are configured to be flexible. When the state changes from the state in FIG. 9A to the state where the developing rollers 6 are in contact with the photosensitive drums 4 in FIG. 9B, the caps 811 move in the direction opposite to the X direction indicated by the arrow as described above, and hence the supply pipes 444 are pulled in an extended way. The upstream ends 444u of the supply pipes 444 are communicably fixed to the receiving inlets 429a of the cartridge holder 429. When the caps 811 move in the direction opposite to the X direction indicated by the arrow in FIG. 8A, the supply pipes 444 move to the inner side of the image forming unit 500 (see FIG. 5). More specifically, the central portions of the supply pipes 444Y and 444M move in the Y direction, and the central portions of the supply pipes 444C and 444K move in the direction opposite to the Y direction. This means that each supply pipe 444 approaches each light path L. In the contact state, the laser scanner unit LB emits light to form the light paths L to form latent images on the photosensitive drums 4 in the image forming process. Therefore, in the contact state, the supply pipes 444 are to avoid coming into contact with the light paths L.

Accordingly, the supply pipes 444 are arranged to allow for deformation during the contact/separation operation.

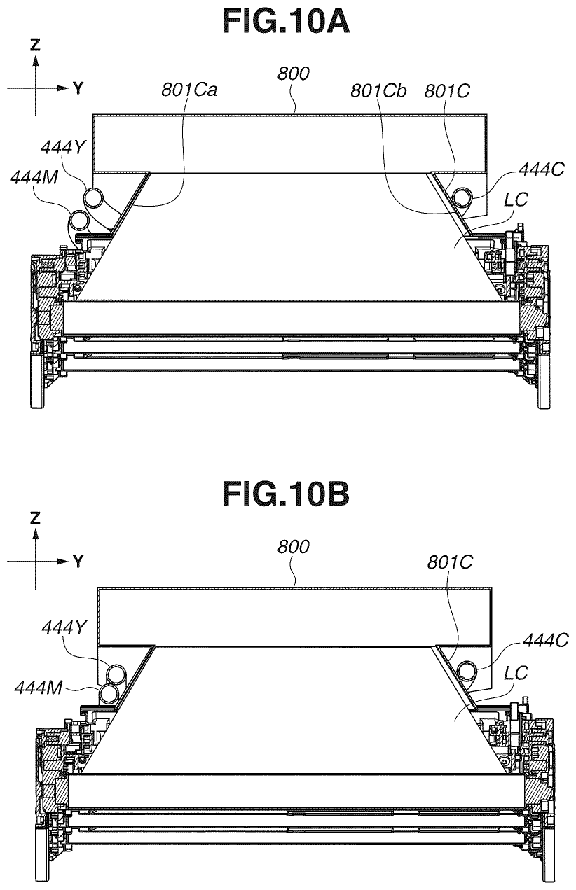

FIG. 10A is a cross-sectional view illustrating a cross-section parallel to the light path LC during laser beam scanning in a state where the developing rollers 6 are separated from the photosensitive drums 4. FIG. 10B is a cross-sectional view illustrating a cross-section parallel to the light path LC in a state where the developing rollers 6 are in contact with the photosensitive drums 4.

As illustrated in FIGS. 10A and 10B, the presence of the guide members 801Ca and 801Cb of the scanner light path cover 801C protects the light path LC from the supply pipes 444, and further allows the supply pipes 444 to be arranged close to the light path LC, thus contributing to the reduction in the size of the apparatus main body 72. The light path LC has been described above with reference to FIGS. 10A and 10B. The description also applies to the light paths LY, LM, and LK.

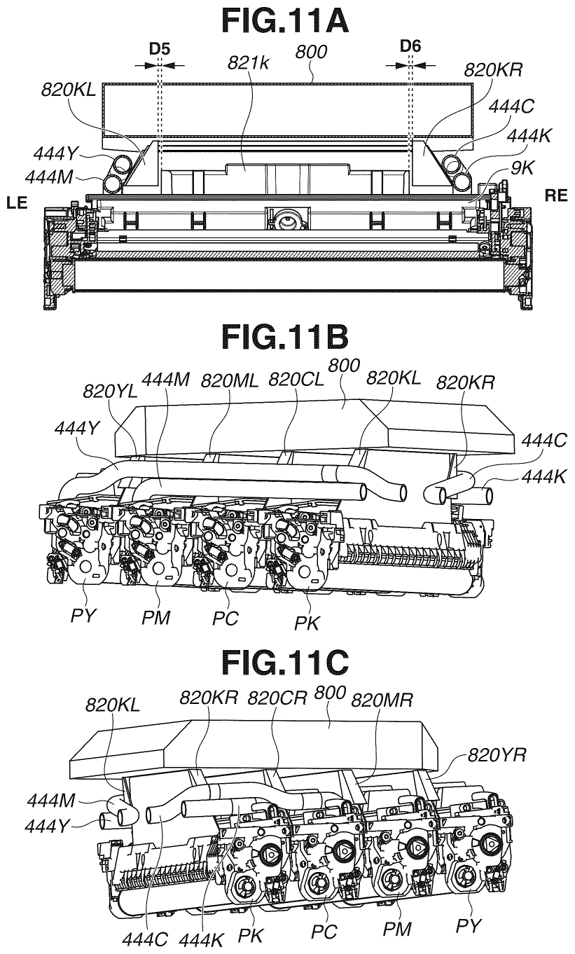

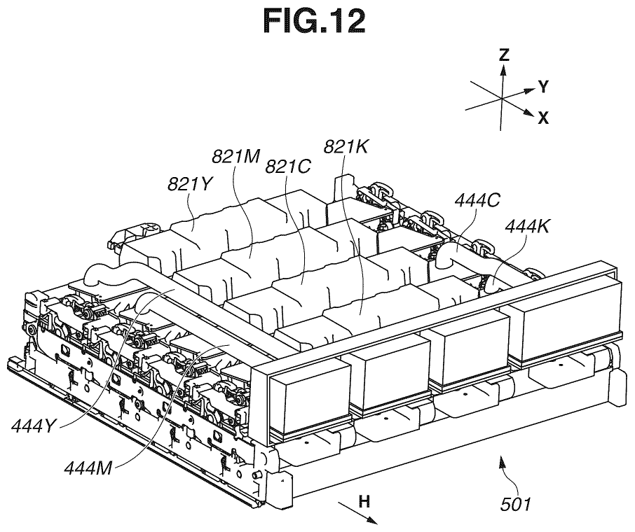

From the viewpoint of the lifetimes of the developing rollers 6 and the photosensitive drums 4, the image forming unit 500 may be configured to be pulled out from the apparatus main body 72. A configuration in this case will be described below as an image forming unit 501 with reference to FIGS. 11A to 11C, and 12.

FIG. 11A is a cross-sectional view illustrating the process unit PK of the image forming unit 501 in a pulling direction H (illustrated in FIG. 12). FIGS. 11B and 11C are perspective views illustrating only the process units P, the supply pipes 444, and the scanner cover 800. FIG. 12 is a perspective view illustrating the image forming unit 501 configured to be pulled out from the apparatus main body 72.

As illustrated in FIG. 11A, a cap 821K of the developing unit 9K of the process unit PK is formed with a predetermined distance D5 provided between the cap 821K and the scanner light path cover 820KL, and, in a similar manner, with a predetermined distance D6 provided between the cap 821K and the scanner light path cover 820KR, thus allowing the image forming unit 501 to be pulled out.

This arrangement also applies to caps 821Y, 821M, and 821C of the developing units 9Y, 9M, and 9C and scanner light path covers 820YL, 820ML, and 820CL in the pulling direction H. Like the above-described station with the black toner color, the caps 821Y, 821M and 821C are formed with the predetermined distance D5 between the caps 821Y 821M and 821C and the scanner light path covers 820YL, 820ML and 820CL. Likewise, the predetermined distance D6 is provided between the caps 821Y, 821M and 821C and scanner light path covers 820YR, 820MR and 820CR, as described above.

As illustrated in FIGS. 11A to 11C, and 12, the connecting portions of the supply pipes 444 and the caps 821 are formed outside the scanner light path covers 820. More specifically, the supply pipes 444Y and 444M are located further to the LE side than the scanner light path covers 820L, and the supply pipes 444C and 444K are located further to the RE side than the scanner light path covers 820R.

The above-described configuration for sending discharged toners together with air from the cartridges 430 to the process units P contributes to the reduction in the size of the apparatus main body 72. More specifically, using the scanner light path covers 801, 820L, and 820R enables protection of the flexible supply pipes 444 from the light paths L. Further, using these covers enables the arrangement of the supply pipes 444 as close to the light paths L as possible.

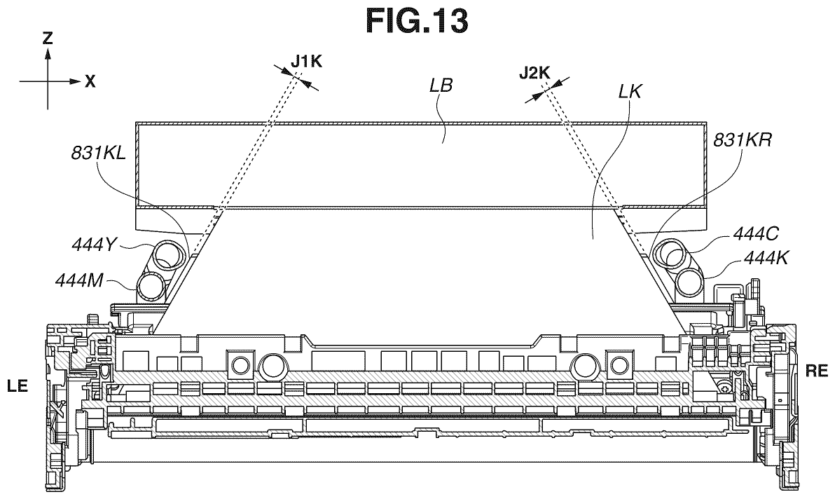

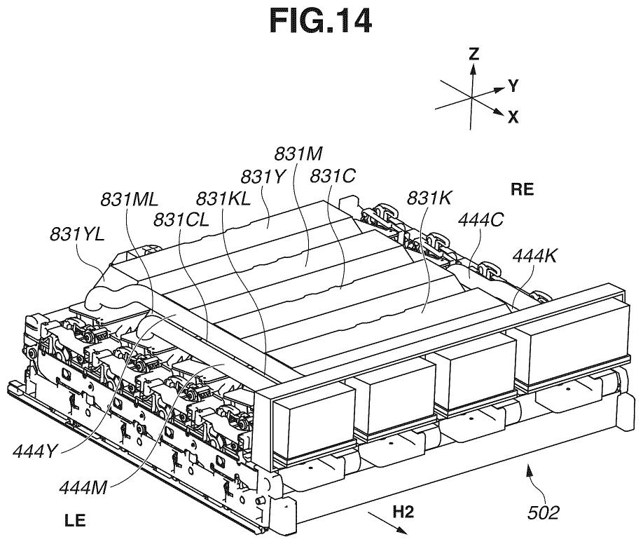

A second exemplary embodiment of the present disclosure will be described below. According to the present exemplary embodiment, the image forming apparatus, image forming operation, detachably attachable cartridges, and toner conveyance are similar to those according to the first exemplary embodiment, and redundant descriptions thereof will be omitted. The configuration of the present exemplary embodiment will be described below with reference to FIGS. 13 and 14.

FIG. 13 is a cross-sectional view (projection surface) illustrating the process unit PK of an image forming unit 502 in a pulling direction H2 (illustrated in FIG. 14). FIG. 14 is a perspective view illustrating the image forming unit 502 according to the second exemplary embodiment.

Forming guide shapes on the scanner cover 800 to protect the supply pipes 444 from the light paths L, like the first exemplary embodiment, also contributes to the reduction in the size of the apparatus main body 72. To allow the image forming unit 502 to be pulled out, the toner containers may be formed in a small size so as to avoid the scanner light path covers, and the toner capacity may be limited.

However, the toner capacity is also an important factor in meeting user needs. When the toner capacity and the function of reducing the size of the apparatus main body 72 are compared, there has been a demand for a configuration for reducing the size of the apparatus main body 72 as small as possible while giving priority to securing a sufficient toner capacity. The present exemplary embodiment will be described below centering on a configuration that satisfies such a demand.

As illustrated in FIG. 13, a guide shape 831KL is formed on the side face of the cap 831K of the process unit PK (fourth developing unit) on the LE side. The guide shape 831KL is formed at a position away from the light path LK by a predetermined distance J1K on the LE side, making it possible to protect the light path LK from the supply pipes 444Y and 444M. Likewise, a guide shape 831KR is formed at a position away from the light path LK by a predetermined distance J2K on the RE side.

This configuration makes it possible to protect the light path LK from the supply pipes 444C and 444K.

More specifically, in the cross-sectional view (projection surface) of the image forming unit 502 in the pulling direction H2, the guide shape 831KL is formed between the supply pipe 444K and the light path LK at a portion on the process unit PK side.

The process unit PK (fourth developing unit) has been described above with reference to FIG. 13. The description also applies to the stations other than the black station illustrated in FIG. 14, i.e., the process unit PY (first developing unit), the process unit PM (second developing unit), and the process unit PC (third developing unit).

More specifically, on the side faces of the caps 831Y, 831M, and 831C on the LE side, guide shapes 831YL, 831ML, and 831CL are formed at positions away from the light paths LY, LM, and LC by predetermined distances J1Y, J1M, and J1C (not illustrated), respectively. On the side faces of the caps 831Y, 831M, and 831C on the RE side, guide shapes 831YR, 831MR, and 831CR are formed at positions away from the light paths LY, LM, and LC by predetermined distances J2Y, J2M, and J2C (not illustrated), respectively.

This configuration also enables the image forming unit 501 to be pulled out together with the guide shapes while securing the toner capacity and protecting the light paths L from the supply pipes 444 like the first exemplary embodiment. Since the guide shape 831YR and the like move together with a pulling operation, the guide shape 831YR is not in frictional contact with the supply pipes 444 during the pulling operation.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2024-158771, filed Sep. 13, 2024, which is hereby incorporated by reference herein in its entirety.

What is claimed is:

1. An image forming apparatus comprising:
a laser scanner;
a first photosensitive drum configured to be irradiated with a laser beam by the laser scanner to form an electrostatic latent image on a surface of the first photosensitive drum, the first photosensitive drum being configured to be rotatable;
a second photosensitive drum configured to be irradiated with a laser beam by the laser scanner to form an electrostatic latent image on a surface of the second photosensitive drum, the second photosensitive drum being arranged in line with the first photosensitive drum in a first direction intersecting with a gravitational direction;
a first developing unit including a first developing roller configured to supply a first toner to the first photosensitive drum to develop a first toner image, and a first developing container configured to store the first toner to be carried by the first developing roller;
a second developing unit including a second developing roller configured to supply a second toner to the second photosensitive drum to develop a second toner image, and a second developing container configured to store the second toner to be carried by the second developing roller;
a first toner container configured to store the first toner to be supplied to the first developing container;
a second toner container configured to store the second toner to be supplied to the second developing container, the second toner container being arranged in line with the first toner container in a second direction intersecting with the gravitational direction and the first direction;
a first pipe configured to allow the first toner to be supplied from the first toner container to the first developing container to pass through, the first pipe being bendable and flexible;
a second pipe configured to allow the second toner to be supplied from the second toner container to the second developing container to pass through, the second pipe being bendable and flexible; and
a wall configured to regulate a position of the first pipe,
wherein the second photosensitive drum is disposed between the first toner container and the first developing container in the first direction,
wherein, in the second direction, a part of the first pipe is disposed to pass a region outside a light path of the laser beam radiated from the laser scanner to the second photosensitive drum, and
wherein at least a part of the wall is a region between the part of the first pipe and the light path in the second direction, and is disposed in a region overlapping with the light path when viewed in a direction of a rotational axis of the second photosensitive drum.

2. The image forming apparatus according to claim 1, wherein in a case where the wall is a first wall portion, the first wall portion is a part of the laser scanner, and is a plate configured to be away from a center of the second photosensitive drum in the second direction as being away from the laser scanner.

3. The image forming apparatus according to claim 1, wherein in a case where the wall is a first wall portion, the first wall portion is a part of the second developing unit, and is a plate configured to be close to a center of the second photosensitive drum in the second direction as being away from the second developing unit.

4. The image forming apparatus according to claim 3, further comprising:
an image forming unit configured to integrally hold the first and the second developing units and the first and the second toner containers,
wherein the image forming unit is configured to be pulled out from an apparatus main body of the image forming apparatus.

5. The image forming apparatus according to claim 1, further comprising:
a third photosensitive drum having a rotational axis along the second direction, the third photosensitive drum being arranged in line with the first photosensitive drum along the first direction, and positioned between the first and the second photosensitive drums in the first direction;
a third developing roller configured to supply a third toner to the third photosensitive drum to develop a third toner image, the third developing roller having a rotational axis along the second direction which is a direction of the rotational axis;
a third developing unit including a third developing container storing the third developing roller;
a third toner container configured to store the third toner, the third toner container being arranged in line with the first toner container in the second direction;
a third pipe connected with the third toner container and the third developing container, and configured to convey the third toner together with air from the third toner container to the third developing container, the third pipe being configured to be bendable in the second direction; and
a second wall portion disposed on a side opposite to a side where the wall as a first wall portion is disposed across the light path in the second direction, the second wall portion being disposed at a position overlapping with the light path in the first direction and disposed outside the light path in the second direction.

6. The image forming apparatus according to claim 1, wherein the laser scanner includes:
a laser light source configured to emit a laser beam;
a polygon mirror configured to reflect, deflect, and scan the laser beam emitted by the laser light source;
a lens configured to form an image of the laser beam scanned by the polygon mirror, on the second photosensitive drum; and
an optical box configured to store and hold the laser light source, the polygon mirror, and the lens,
wherein, in a case where the wall is a first wall portion, the first wall portion is integrally connected with the optical box.

7. The image forming apparatus according to claim 1, further comprising:
a third wall portion as a plate disposed on one side of the light path, the third wall portion extending along the light path, when viewed in the second direction; and
a fourth wall portion as a plate disposed on another side of the light path, the fourth wall portion extending along the light path, when viewed in the second direction,
wherein, in a case where the wall is a first wall portion, the third and the fourth wall portions are connected by the first wall portion.

8. The image forming apparatus according to claim 1,
wherein the first developing roller is configured to be movable between a contact position where the first developing roller is in contact with the first photosensitive drum and a separation position where the roller is separated from the first photosensitive drum, and
wherein, in a cross-section along the light path of the laser beam emitted from the laser scanner, a distance between the first pipe and the light path is shorter at the contact position than at the separation position.

9. The image forming apparatus according to claim 1,
wherein, in a case where a rotational axis of the first photosensitive drum is a first rotational axis, the first developing roller is configured to be movable between a contact position where the first developing roller is in contact with the first photosensitive drum and a separation position where the first developing roller is separated from the first photosensitive drum, when the first developing unit including the first developing roller rotates around a second rotational axis parallel to the first rotational axis, relative to a first drum unit having the first photosensitive drum, and
wherein, when viewed in the second direction, the first pipe is positioned above the second rotational axis, and the first photosensitive drum is positioned below the second rotational axis in the gravitational direction.
